(19) United States
(12) Patent Application Publication
(10) Pub. No.: US 2026/0064425 A1
(43) Pub. Date: Mar. 5, 2026

(54) CHAINED RETIREMENT

(71) Applicant: QUALCOMM Incorporated, San Diego, CA (US)

(72) Inventors: Damian MAIORANO, San Jose, CA (US); Priyank Satish DESHPANDE, Mountain View, CA (US)

(21) Appl. No.: 18/821,332

(22) Filed: Aug. 30, 2024

(51) Int. Cl. G06F 9/38

(52) U.S. Cl. CPC G06F 9/3838; G06F 9/3836; G06F 9/384; G06F 9/3854

(57) ABSTRACT

Certain aspects of the present disclosure provide techniques for freeing physical register tags, generally including fetching a set of instructions for out-of-order execution, wherein the set of instructions includes at least one target instruction that depends on at least first and second parent instructions as sources of data, mapping a destination architectural register of the target instruction to a physical tag selected from a list of free tags, creating an entry in a lookup table to track dependency between the target instruction and the first and second parent instructions, updating the entry based on execution of the first and second parent instructions, and freeing the physical tag prior to retirement of a releasing instruction that writes to the destination architectural register, if at least one condition is met after updating the entry.

### TECHNICAL FIELD

Certain aspects of the present disclosure generally relate to out of order (OoO) processing and, more particularly, to techniques for managing resources used in OoO processing.

### BACKGROUND

An out-of-order (OoO) processor generally refers to a type of CPU architecture that improves performance by executing instructions not strictly in the order they appear in the program. Rather, an OoO processor dynamically schedules instructions to be executed in “data order” based on the availability of input data and execution resources, rather than their original order in the program code.

With OoO processing, instructions are fetched from memory in the order they appear in the program. After fetching, instructions are decoded to determine what operations need to be performed. Decoded instructions are placed into an instruction queue. This queue holds instructions until they are ready to be executed.

An OoO processor checks the instructions in the queue to determine if they have any dependencies (e.g., an instruction that requires the result of a previous instruction). If an instruction has all the data it needs and the necessary execution unit is available, it can be executed immediately, even if earlier instructions are still waiting for their dependencies.

With OoO processing, instructions are sent to execution units as soon as they are ready (e.g., they have the data they need and processing resources are available), rather than waiting for earlier (in programs order) instructions to finish.

While instructions may be executed out-of-order, they are still typically retired (or completed) in the correct program order, in order to maintain the logical correctness of the program. After execution, instructions are placed in a buffer, often called a reorder buffer (ROB). The OoO processor ensures that the results of the instructions are committed to the architectural state (e.g., registers, memory) in the order they were fetched (program order). This process, known as in-order retirement, is designed to ensure that even though instructions were executed out-of-order, the program behaves in the expected manner, as if they were executed in the original sequence.

By executing instructions as soon as their dependencies are resolved, OoO processors can achieve better utilization of processing resources, resulting in performance gains.

### BRIEF SUMMARY

Certain aspects provide a method of expediting the freeing a physical register tag used in a renaming function of an out of order (OoO) processor. The method generally includes fetching a set of instructions for out-of-order execution, wherein the set of instructions includes at least one target instruction that depends on at least first and second parent instructions as sources of data, mapping a destination architectural register of the target instruction to a physical tag selected from a list of free tags, creating an entry in a lookup table to track dependency between the target instruction and the first and second parent instructions, updating the entry based on execution of the first and second parent instructions, and freeing the physical tag prior to retirement of a releasing instruction that writes to the destination architectural register, if at least one condition is met after updating the entry.

Other aspects provide an out of order (OoO) processor configured to perform the aforementioned method as well as those described herein; and an OoO processor comprising means for performing the aforementioned method as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts an example computing environment for out of order (OoO) processing according to various aspects of the present disclosure.

FIG. 2 depicts an example stream of instructions that may be executed out of order (OoO), according to various aspects of the present disclosure.

FIGS. 3A-3D depict an example structure that may be used to track dependencies of instructions processed OoO, according to various aspects of the present disclosure.

FIG. 4 depicts a method for chained retirement according to various aspects of the present disclosure.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Certain aspects of the present disclosure generally relate to managing resources used in out of order (OoO) processing.

As noted above, by executing instructions as soon as their dependencies are resolved, OoO processors can achieve better utilization of processing resources, resulting in performance gains. There are various potential hazards, however, associated with OoO processing. Examples of such hazards include a write after read (WAR) hazard and a write after write (WAW) hazard. These hazards may exist due to a limited number of instruction set architecture (ISA) registers and loops that use the same register specifiers on each iteration.

Certain OoO processors may utilize a mechanism referred to as register renaming to avoid certain scenarios referred to as eliminate WAR and WAW hazards. Register renaming is typically accomplished by including non-architectural renaming registers to an OoO processor. While these registers are not available to programmers directly, because they are not part of the architecture, they are available to the OoO processor to eliminate hazards. For example, to avoid a WAR hazard that might occur between subtraction (SUB) and addition (ADD) instructions the OoO processor could rename a register of the SUB instruction to a register that has no dependency on the ADD instruction. The OoO processor typically keeps a table with physical tags to track which registers were renamed, so that it can consistently rename registers in subsequent dependent instructions.

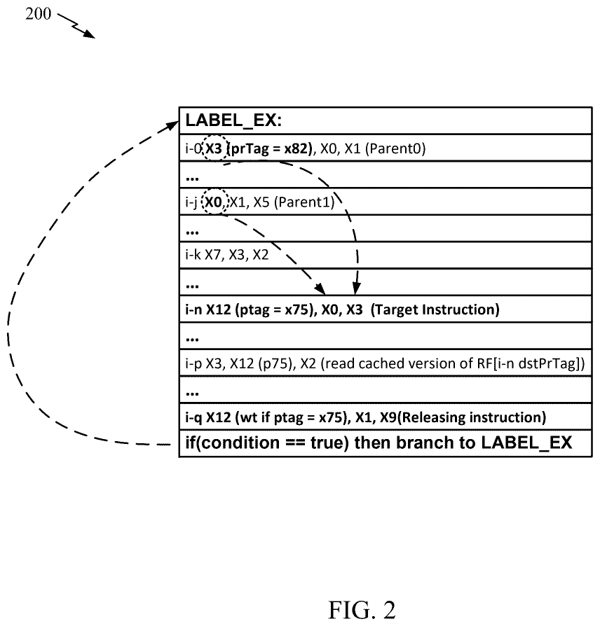

One potential limitation with OoO renaming is that certain conditions may result in stalls. For example, as will be described in greater detail below with reference to FIG. 2, if a target instruction is dependent on two other parent instructions, an OoO processor may not be able to retire a resource associated with a destination for the target instruction only when another releasing instruction is retired.

As a result, a physical tag associated with the destination of the target instruction may potentially hang (not able to be freed) for many cycles, despite the potential to never have been read or been read only a few times by other instructions that have that resource as a source. This might incur performance penalties, particularly in cases where register file depth (e.g., due to a limited number of physical tags and corresponding registers) is a bottleneck.

Aspects of the present disclosure provide a mechanism that may help avoid such stalls by freeing up physical tags sooner. The mechanism may be referred to as chained retirement because it utilizes a data structure (e.g., a look up table) to monitor execution of dependent instructions (e.g., parent instructions that generate data needed by a target instruction). Once certain conditions are met, a physical tag associate with a destination of the target instruction may be freed up ahead of time, which may help avoid potential stalls described above and improve overall performance.

### Example OoO Computing Environment

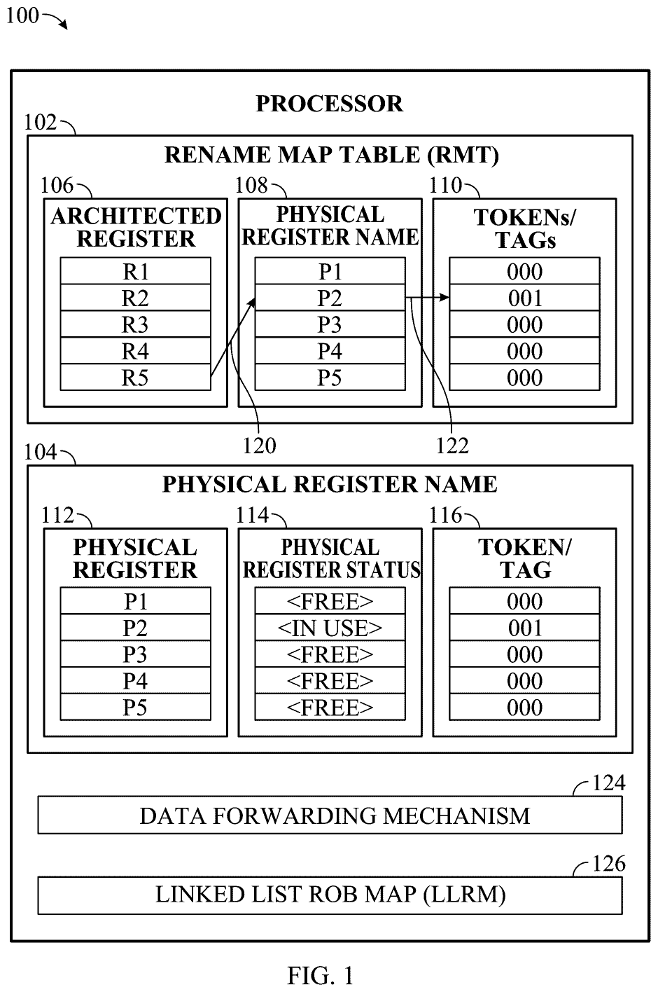

FIG. 1 illustrates a block diagram of an example OoO processor 100 according to one or more implementations described herein. The illustrated processor 100 is an out-of-order processor that utilizes register renaming during execution of instructions in the instruction pipeline.

Processor 100 may include a pipeline that receives data from a data cache and instructions from an instruction cache. A controller typically controls various stages and execution units (such as a fetch stage, a decode stage, etc.) within the pipeline to decode and execute instructions. Results from the executed instructions when they complete may be stored in a register file, in a data cache, and in other buffers or memory units.

The illustrated processor 100 includes a register renaming mechanism, which changes register names from architected register names to physical register names. As noted above, register renaming may be performed in order to eliminate processor performance-sapping data hazards such as read-after-write (RAW) data hazards and write-after-write (WAW) data hazards.

The illustrated register renaming mechanism includes a rename map table (RMT) 102. In one or more implementations, the RMT 102 is any suitable mechanism that maps architected registers to physical registers in a processor. The RMT 102 is capable of being dynamically updated to reflect new mappings of architected registers to physical registers, including dynamically updating of identifiers such as tokens, token counts, sequence identifiers, and the like.

For example, when an instruction is to write a result to a physical register, the allocated or assigned physical register location for the instruction result is recorded in the RMT 102. When an instruction is to read a result from a physical register, the RMT 102 is consulted to determine the allocated or assigned physical register location where the instruction result is to be recorded. It is to be noted that architected registers are not actual physical locations within the processor 100. Instead, architected registers are the names of registers generated by processor's instructions according to the ISA for a particular processor.

The illustrated register renaming mechanism includes a physical register file (PRF) 104. In one or more implementations, the PRF is a file including the physical registers that are implemented in the processor 100 hardware. Physical registers hold results of instructions that have already committed as well as results of subsequent instructions that have not yet committed. Typically there are many more physical registers than architected registers.

The illustrated RMT 102 includes an architected register column 106 and a physical register name (PRN). The architected register column 106 is not a physical entity. Instead, the architected register column is just indicative of an index used to access a corresponding entry in the PRN column 108. The PRN column 108 is indexed by the name of an architected register.

The PRN column 108 includes physical registers P1-P5, though typically there are many more physical registers than architected registers. Architected registers R1-R5 are renamed to physical registers P1-P5 in this example. In one or more implementations, using identifiers, such as tokens and/or instruction sequence IDs (e.g., Re-Order Buffer ID, Matrix ID, etc.), an architected register can reuse an already in-use physical register.

For example, the illustrated RMT 102 includes a token/tag column 110. In the illustrated embodiment, the tokens (or physical tags) in the column 110 are three bits long, although according to implementations the tokens can be any number of bits, such as one bit, two bits, ten bits, and so forth.

The illustrated PRF 104 includes a physical register column 112. The physical register column 112 includes physical registers P1-P5, although typically there are many more physical registers.

The illustrated PRF 104 includes a physical register status column 114 indexed by the name of a physical register. The physical register status column 114 indicates whether a particular physical register is free or in use. For example, in the illustrated example the physical register status column 114 indicates that the physical register P2 is <in use> and all other physical registers are <free>. The <in use> designation indicates that the physical register has been assigned to an architected register and that the generating instruction is to write its result into that assigned physical register. According to implementations, physical registers that are <in use> can be reused by another generation of an architected register. The <free> designation indicates that the physical register has not been assigned to an architected register and that the generating instruction can be assigned that physical register. According to implementations, physical registers that are <in use> can be reused by another generation of an architected register.

The illustrated PRF 104 includes a token/tag column 116. The tokens in the column 116 are three bits long, although according to embodiments the tokens can be any number of bits, such as one bit, two bits, ten bits, and so forth. The token/tag for the physical register P2 in the column 116 also has its least significant bit set to “1.”

In the example illustrated in FIG. 1, an arrow 120 indicates that the architected register R5 has been renamed (or mapped to) physical register P2, and an arrow 122 indicates that the token for physical register P2 has its least significant bit set to “1.”

The illustrated processor 100 includes a data forwarding mechanism 124. The illustrated data forwarding mechanism 124 allows data-dependent instructions to be executed in consecutive cycles. For example, the data-forwarding mechanism 124 enables data to be sent directly between functional units in the processor 100, bypassing the PRF.

### Example Chained Retirement

Aspects of the present disclosure provide a chained retirement mechanism that may help avoid potential stalls that occur with OoO renaming under certain conditions. The chained retirement mechanism proposed herein may utilize a data structure (e.g., a look up table), such as the linked list ROB map (LLRM) 126 shown in FIG. 1 to monitor execution of dependent instructions (e.g., parent instructions that generate data needed by a target instruction).

Potential stalls associated with OoO renaming may be understood by considering an example instruction stream 200 shown in FIG. 2. The naming convention for instructions I-x in FIG. 2 is in the form of:
I-x Dst, Src0, Src1;
   where I-x is the instruction ID (or index) and dst is the destination (e.g., register to store results generated by the instruction, while src0 and src1 are source registers (e.g., with data the instruction acts on).

If one instruction (e.g., a target instruction I-n) is dependent on two other instructions (e.g., parent instructions I-0 and I-j), an OoO processor may not be able to retire a resource associated with destination (e.g., register X12) only when another instruction (e.g., releasing instruction I-q) is retired.

As a result, the physical tag (X75) associated with the destination X12 may potentially hang (not able to be freed) for many cycles, despite the potential to never have been read or been read only a few times by instructions (e.g., I-p) that have X12 as a source. This might incur performance penalties, particularly in cases where register file depth (e.g., due to a limited number of physical tags and corresponding registers) is a bottleneck.

By monitoring execution of instructions at the rename stage (e.g., using a look up table structure such as LLRM 126) a potentially long-latency physical tag associated with a destination of the target instruction may be freed up ahead of time, when certain conditions are met. This early freeing up of physical tags may help avoid potential stalls described above and improve overall performance.

Chained retirement tries to alleviate this issue by freeing these long-latency physical tags ahead of time and avoid potential stalls. Entries in the LLRM may be populated and updated, for example, in the rename retirement stages. Each entry may monitor dependence of a target instruction and corresponding parent instructions. LLRM depth (e.g., the number of entries and/or number of dependent instructions supported) is a design decision and may represent a tradeoff between performance benefits and expense, in terms of area and power consumption. In other words, higher LLRM depth may result in higher performance benefits, but at an increased cost of area and power.

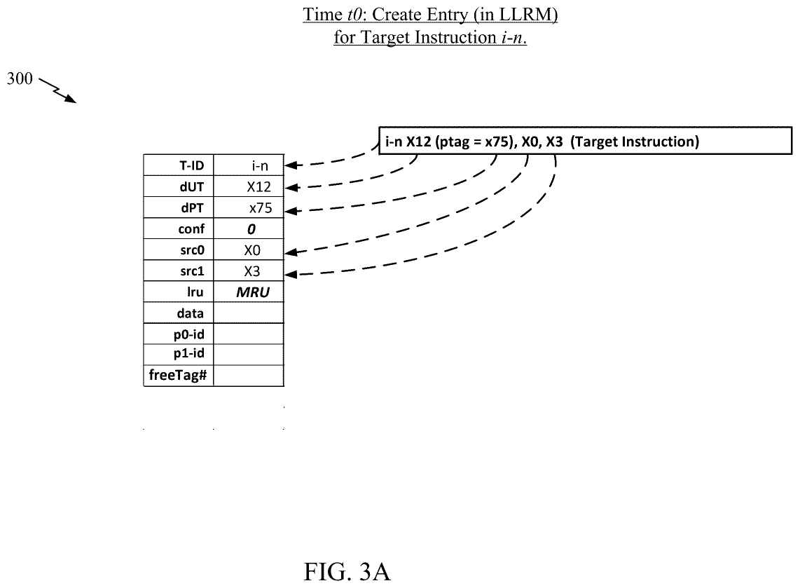

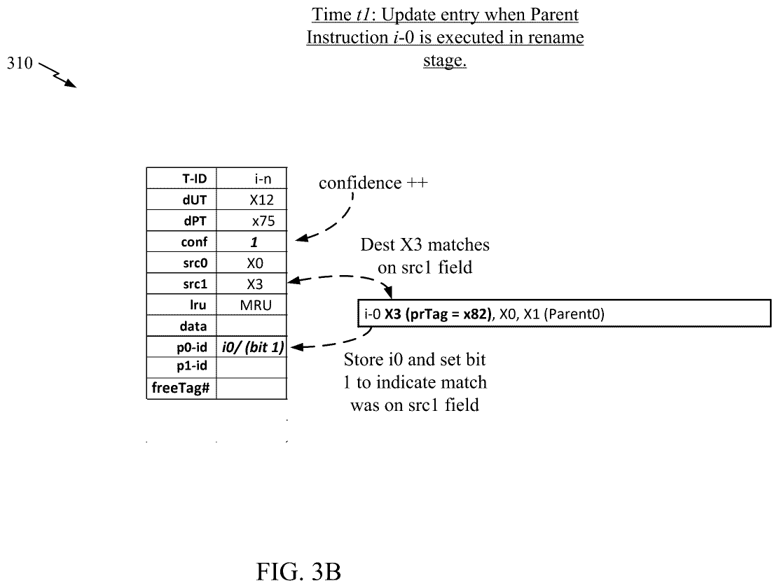

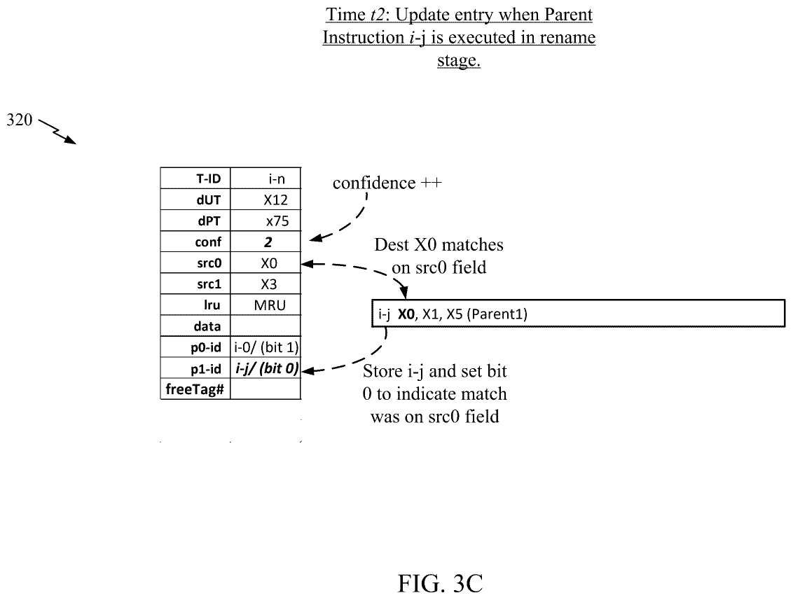

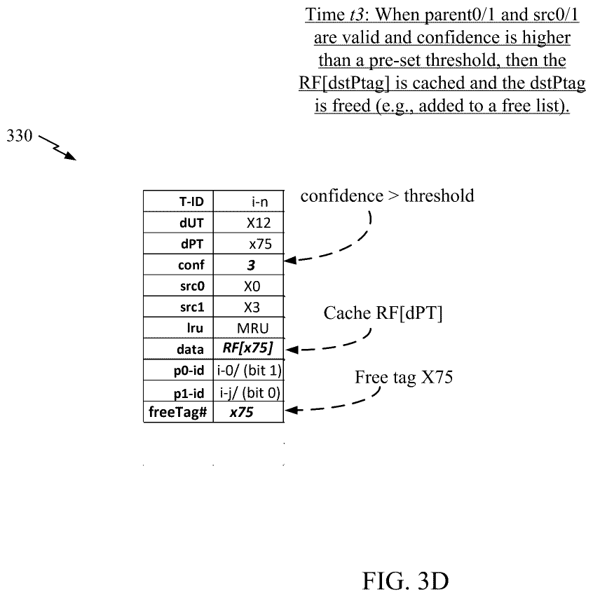

FIG. 3A illustrates an example structure for an LLRM entry 300. As illustrated, each entry may be formed by multiple fields.

As illustrated, the fields may include a target instruction ID (T-ID) field. In some cases, the T-ID field may be used for flushing an entry on a speculative flush. For example, if a flushID is older than the T-ID, the entry may be cleared.

The entry 300 may also include a destination field of the target instruction (dUT) and a corresponding field (dPT) to store an ID of a physical tag for (renaming) the destination of the target instruction. The entry 300 may also include fields (src0 and src1) to store destination fields of parent instructions (Parent 0 and Parent 1) that are sources of the target instruction.

The entry 300 may also include fields (p0-ID and pl-ID) to store IDs of the parent instructions. In some cases, these fields may also include 2 bits used to indicate whether the destination field of a corresponding parent instruction is the first source (src0) or second source (src1) of the target instruction. For example, the OoO processor may set a corresponding bit 0 if the destination field is used for source 0 of the parent instruction or may set bit 1 if the destination field is used for source 1.

According to certain aspects, the entry 300 may also include a field (conf) that may represent a level of confidence that a physical tag for an entry may be freed early. As will be described with reference to FIGS. 3B-3D, a value in the confidence field may be incremented when an instruction in the rename stage is executed and its destination (dst) matches one of the source (src0/src1) fields in an LLRM entry.

In some cases, data from a corresponding register file may be cached in a data field (data) when certain conditions are met, allowing the physical tag to be freed ahead of time (e.g., before retirement of a releasing instruction). For example, in order to cache the data (and, therefore free the physical tag indicated in dPT) for a given entry, the parent IDs (p0-ID and p1-ID) and source fields (src0 and src1) may need to be populated (e.g., considered valid with each field being set).

How an LLRM entry 300 may be used to free a physical tag early may be understood with reference to the example depicted in FIGS. 3A-3D. The example assumes the same sequence of instructions 200 illustrated in FIG. 2.

As illustrated in FIG. 3A, at a time t0, an LLRM entry for target instruction I-n may be first populated at a rename stage. In the example illustrated in FIG. 3A, upon creation, the T-ID field is populated with I-n, the dUT field is populated with X12, the dPT field is populated with the physical tag ID X75, and the source fields (src0 and src1) are populated with X0 and X3, respectively.

In some cases, there may be certain constraints on allocating an LLRM entry. For example, the LLRM entry may be populated for a target instruction assuming the instruction is not a waypoint and it has only two sources (although this constraint on number of sources is an example only). In some cases, an entry may be made in an empty position in the LLRM and, upon creation, a field (LRU) may be updated to indicate that the entry is most recently used (MRU). Further, the confidence field may be initially set to zero upon allocation.

As illustrated in FIG. 3B, which illustrates an example structure for an LLRM entry 310, at a time t1, when parent instruction I-0 is executed in the rename stage, because its destination (X3) matches field src1, parent ID field p0-id is populated with I-0 and bit 1 (of the two-bit field) is set (to indicate the match was on the src1 field). The confidence field may also be incremented (indicated as confidence++).

Similarly, as illustrated in FIG. 3C, which illustrates an example structure for an LLRM entry 320, at a time t2, when parent instruction I-j is executed in the rename stage, because its destination (X0) matches field src0, parent ID field p1-id is populated with I-j and bit 0 (of the two-bit field) is set (to indicate the match was on the src0 field). The confidence field may also be incremented (indicated as confidence++).

As illustrated in FIG. 3D, which illustrates an example structure for an LLRM entry 330, at a later time t3, when certain conditions are met, data from register file corresponding to physical tag X75 may be cached in the data field (data), allowing the physical tag X75 to be freed.

For example, the conditions may be considered met because the parent IDs (p0-ID and p1-ID) and source fields (src0 and src1) are populated and the confidence field is higher than a pre-set threshold. In the illustrated example, the pre-set threshold may be 2, so a confidence level of 3 satisfies this condition. As a result, data from the corresponding register file RF[X75] may be cached in the data field and the physical tag in the dPT field (X75) may be freed (e.g., added to free list). In some cases, this may be accomplished by adding X75 to a register (freeTag #) in the entry 300.

When parent instruction I-0 is executed in the rename stage, because its destination (X3) matches field src1, parent ID field p0-id is populated with I-0 and bit 1 (of the two-bit field) is set (to indicate the match was on the src1 field). The confidence field may also be incremented (indicated as confidence++). Caching the data in this manner may allow subsequently executed instructions (e.g., instruction I-p in FIG. 2) to read (intended) source data from the LLRM entry after freeing of the physical tag.

As noted above, certain factors, such as the depth of the LLRM may be design considerations. For example, the deeper the LLRM, the more resources needed to cache a greater number of RF[dPT] data to ensure subsequent instructions (e.g., instruction I-p in FIG. 2) can correctly read their source data.

As another example, power consumption may be reduced if the LLRM is not accessed every cycle. In some cases, some type of filtering or condition may be used to populate or check the LLRM in only certain cases (e.g., based on constraints on the type of instruction and/or number of sources).

### Example Method for Chained Retirement

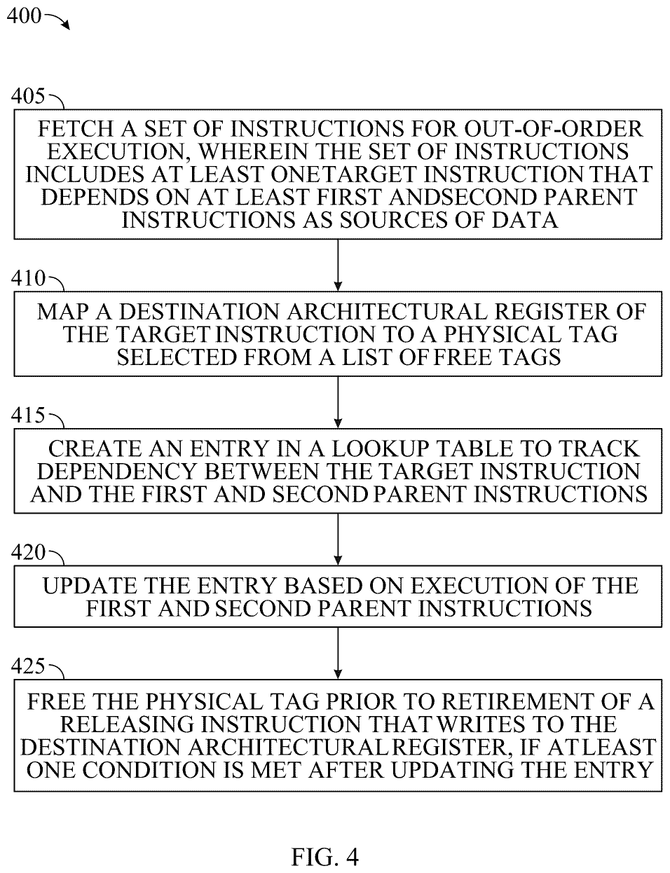

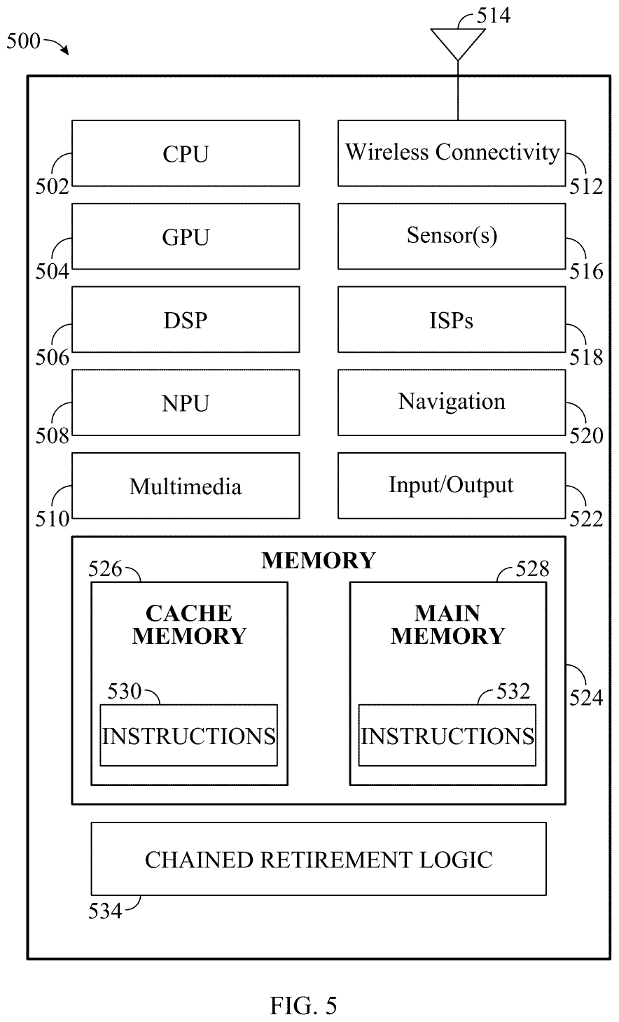

FIG. 4 is a diagram depicting an example method 400 for chained retirement, according to various aspects of the present disclosure. For example, method 400 may be performed by the OoO processor 100 of FIG. 1 and/or by a processing system such as processing system 500 of FIG. 5, described below.

Method 400 begins at block 405, with fetching a set of instructions for out-of-order execution, wherein the set of instructions includes at least one target instruction that depends on at least first and second parent instructions as sources of data.

Method 400 continues at block 410, with mapping a destination architectural register of the target instruction to a physical tag selected from a list of free tags.

Method 400 continues at block 415, with creating an entry in a lookup table to track dependency between the target instruction and the first and second parent instructions.

Method 400 continues at block 420, with updating the entry based on execution of the first and second parent instructions.

Method 400 continues at block 425, with freeing the physical tag prior to retirement of a releasing instruction that writes to the destination architectural register, if at least one condition is met after updating the entry.

### Example Processing System

In some aspects, the techniques and methods described with reference to FIGS. 2-4 may be implemented on one or more devices or systems. FIG. 5 depicts an example processing system 500 configured to perform various aspects of the present disclosure, including, for example, the techniques and methods described with respect to FIGS. 2-4. In some aspects, the processing system 500 may correspond to processor 100 of FIG. 1. Although depicted as a single system for conceptual clarity, in some aspects, as discussed above, the operations described below with respect to the processing system 500 may be distributed across any number of devices or systems.

The processing system 500 includes a central processing unit (CPU) 502 (e.g., corresponding to processor 100 of FIG. 1). Instructions executed at the CPU 502 may be loaded, for example, from a cache memory (e.g., corresponding to the cache memory) associated with the CPU 502.

The processing system 500 also includes additional processing components tailored to specific functions, such as a graphics processing unit (GPU) 504, a digital signal processor (DSP) 506, a neural processing unit (NPU) 508, a multimedia component 510 (e.g., a multimedia processing unit), and a wireless connectivity component 512.

An NPU, such as NPU 508, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS), as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

The memory 524 may include cache memory 526 (e.g., corresponding to the cache memory). The memory 524 may also include main memory 528. The cache memory 526 may include instructions 530 to be executed by the CPU 502. The main memory 528 also includes instructions 532 to be executed by the CPU 502. In some cases, a prefetcher may anticipate that the CPU 502 needs instructions 532 from the main memory 528 and fetch the instructions 532 from the main memory 528 and load the instructions 532 into the cache memory 526 before the instructions 532 are requested by the CPU 502.

Generally, the processing system 500 and/or components thereof may be configured to perform the methods described herein. For example, the processing system 500 may include chained retirement logic 543 configured to perform the disclosed techniques, such as the method of FIG. 4.

Notably, in other aspects, elements of the processing system 500 may be omitted, such as where the processing system 500 is a server computer or the like. For example, the multimedia component 510, the wireless connectivity component 512, the sensor processing units 516, the ISPs 518, and/or the navigation processor 520 may be omitted in other aspects. Further, aspects of the processing system 500 may be distributed between multiple devices.

### Example Clauses

Implementation examples are described in the following numbered clauses:

Clause 1: A method, comprising: fetching a set of instructions for out-of-order execution, wherein the set of instructions includes at least one target instruction that depends on at least first and second parent instructions as sources of data; mapping a destination architectural register of the target instruction to a physical tag selected from a list of free tags; creating an entry in a lookup table to track dependency between the target instruction and the first and second parent instructions; updating the entry based on execution of the first and second parent instructions; and freeing the physical tag prior to retirement of a releasing instruction that writes to the destination architectural register, if at least one condition is met after updating the entry.

Clause 2: The method of Clause 1, wherein the entry includes a field indicating, upon creation, that the entry is a most recently used (MRU) entry.

Clause 3: The method of any one of Clauses 1-2, wherein the entry includes: a target ID field populated based on an ID of the target instruction; a destination field populated based on an ID of the destination architectural register of the target instruction; and a physical tag field populated based on an ID of the physical tag.

Clause 4: The method of any one of Clauses 1-3, wherein the entry includes: a first source field populated based on a first source architectural register of the target instruction; and a second source field populated based on a second source architectural register of the target instruction.

Clause 5: The method of Clause 4, wherein updating the entry comprises: updating a first parent ID field of the entry with an ID of the first parent instruction, based on a match between a destination field of the first parent instruction and the first source field or a match between the destination field of the first parent instruction and the second source field; and updating a second parent ID field of the entry with an ID of the second parent instruction, based on a match between a destination field of the second parent instruction and the first source field or a match between the destination field of the second parent instruction and the second source field.

Clause 6: The method of Clause 5, wherein updating the entry further comprises: updating a bit in the first parent ID field to indicate whether the match of the destination field of the first parent instruction was with the first source field or the second source field; and updating a bit in the second parent ID field to indicate whether the match of the destination field of the second parent instruction was with the first source field or the second source field.

Clause 7: The method of Clause 5, wherein the updating further comprises updating a confidence field of the entry based on at least one of: the match between of the destination field of the first parent instruction and the first source field or the second source field; or the match between of the destination field of the first parent instruction and the first source field or the second source field.

Clause 8: The method of Clause 7, wherein the at least one condition is considered met if the confidence field exceeds a threshold value.

Clause 9: The method of any one of Clauses 1-8, further comprising: caching data stored in a location associated with the physical tag prior to or when releasing the physical tag.

Clause 10: An apparatus, comprising: at least one memory comprising executable instructions; and at least one processor configured to execute the executable instructions and cause the apparatus to perform a method in accordance with any combination of Clauses 1-9.

Clause 11: An apparatus, comprising means for performing a method in accordance with any combination of Clauses 1-9.

Clause 12: A non-transitory computer-readable medium comprising executable instructions that, when executed by at least one processor of an apparatus, cause the apparatus to perform a method in accordance with any combination of Clauses 1-9.

Clause 13: A computer program product embodied on a computer-readable storage medium comprising code for performing a method in accordance with any combination of Clauses 1-9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining”may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S. C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus, comprising:
circuitry configured to fetch a set of instructions for out-of-order execution, wherein the set of instructions includes at least one target instruction that depends on at least first and second parent instructions as sources of data;
circuitry configured to map a destination architectural register of the target instruction to a physical tag selected from a list of free tags;
circuitry configured to create an entry in a lookup table to track dependencies between the target instruction and the first and second parent instructions, wherein the entry includes:
a first source field populated with at least an ID of a first source architectural register of the target instruction; and
a second source field populated with at least an ID of a second source architectural register of the target instruction;
circuitry configured to update the entry based on execution of the first and second parent instructions; and
circuitry configured to free the physical tag prior to retirement of a releasing instruction that writes to the destination architectural register, if at least one condition is met after updating the entry.

2. The apparatus of claim 1, wherein the entry further includes a field indicating, upon creation, that the entry is a most recently used (MRU) entry.

3. The apparatus of claim 1, wherein the entry further includes:
a target ID field populated based on an ID of the target instruction;
a destination field populated based on an ID of the destination architectural register of the target instruction; and
a physical tag field populated based on an ID of the physical tag.

4. (canceled)

5. The apparatus of claim 1, wherein the circuitry configured to update the entry is configured to:
update a first parent ID field of the entry with an ID of the first parent instruction, based on a match between a destination field of the first parent instruction and the first source field or a match between the destination field of the first parent instruction and the second source field. wherein the destination field of the first parent instruction is populated with an ID of the destination architectural register of the target instruction; and
update a second parent ID field of the entry with an ID of the second parent instruction, based on a match between a destination field of the second parent instruction and the first source field or a match between the destination field of the second parent instruction and the second source field.

6. The apparatus of claim 5, wherein the circuitry configured to update the entry is further configured to:
update a bit in the first parent ID field to indicate whether the match of the destination field of the first parent instruction was with the first source field or the second source field; and
update a bit in the second parent ID field to indicate whether the match of the destination field of the second parent instruction was with the first source field or the second source field.

7. The apparatus of claim 5, wherein the circuitry configured to update the entry is further configured to update a confidence field of the entry based on at least one of:
the match between the destination field of the first parent instruction and the first source field or the second source field; or
the match between the destination field of the second parent instruction and the first source field or the second source field.

8. The apparatus of claim 7, wherein the at least one condition is considered met if the confidence field exceeds a threshold value.

9. The apparatus of claim 1, further comprising:
circuitry configured to cache data stored in a location associated with the physical tag prior to or when releasing the physical tag.

10. The apparatus of claim 9, wherein the data stored in a location associated with the physical tag is cached in a data field of the entry.

11. A method of out-of-order processing, comprising:
fetching a set of instructions for out-of-order execution, wherein the set of instructions includes at least one target instruction that depends on at least first and second parent instructions as sources of data;
mapping a destination architectural register of the target instruction to a physical tag selected from a list of free tags;
creating an entry in a lookup table to track dependencies between the target instruction and the first and second parent instructions, wherein the entry includes:
a first source field populated with at least an ID of a first source architectural register of the target instruction; and
a second source field populated with at least an ID of a second source architectural register of the target instruction;
updating the entry based on execution of the first and second parent instructions; and
freeing the physical tag prior to retirement of a releasing instruction that writes to the destination architectural register, if at least one condition is met after updating the entry.

12. The method of claim 11, wherein the entry further includes a field indicating, upon creation, that the entry is a most recently used (MRU) entry.

13. The method of claim 11, wherein the entry further includes:
a target ID field populated based on an ID of the target instruction;
a destination field populated based on an ID of the destination architectural register of the target instruction; and
a physical tag field populated based on an ID of the physical tag.

14. (canceled)

15. The method of claim 11, wherein updating the entry comprises:
updating a first parent ID field of the entry with an ID of the first parent instruction, based on a match between a destination field of the first parent instruction and the first source field or a match between the destination field of the first parent instruction and the second source field. wherein the destination field is populated with an ID of the destination architectural register of the target instruction; and
updating a second parent ID field of the entry with an ID of the second parent instruction, based on a match between a destination field of the second parent instruction and the first source field or a match between the destination field of the second parent instruction and the second source field.

16. The method of claim 15, wherein updating the entry further comprises:
updating a bit in the first parent ID field to indicate whether the match of the destination field of the first parent instruction was with the first source field or the second source field; and
updating a bit in the second parent ID field to indicate whether the match of the destination field of the second parent instruction was with the first source field or the second source field.

17. The method of claim 15, wherein the updating further comprises updating a confidence field of the entry based on at least one of:
the match between of the destination field of the first parent instruction and the first source field or the second source field; or
the match between of the destination field of the first parent instruction and the first source field or the second source field.

18. The method of claim 17, wherein the at least one condition is considered met if the confidence field exceeds a threshold value.

19. The method of claim 11, further comprising:
caching data stored in a location associated with the physical tag prior to or when releasing the physical tag.

20. An apparatus, comprising:
means for fetching a set of instructions for out-of-order execution, wherein the set of instructions includes at least one target instruction that depends on at least first and second parent instructions as sources of data;
means for mapping a destination architectural register of the target instruction to a physical tag selected from a list of free tags;
means for creating an entry in a lookup table to track dependencies between the target instruction and the first and second parent instructions, wherein the entry includes:
a first source field populated with at least an ID of a first source architectural register of the target instruction; and
a second source field populated with at least an ID of a second source architectural register of the target instruction;
means for updating the entry based on execution of the first and second parent instructions; and
means for freeing the physical tag prior to retirement of a releasing instruction that writes to the destination architectural register, if at least one condition is met after updating the entry.
